(19) United States
(12) Patent Application Publication
(10) Pub. No.: US 2023/0055012 A1
(43) Pub. Date: Feb. 23, 2023

(54) DYNAMIC VEHICLE OPERATION

(71) Applicant: Ford Global Technologies, LLC, Dearborn, MI (US)

(72) Inventors: Lijun Wang, Canton, MI (US); Chen Zhang, Dearborn, MI (US); Kai Wu, Ann Arbor, MI (US); Yan Wang, Ann Arbor, MI (US)

(73) Assignee: Ford Global Technologies, LLC, Dearborn, MI (US)

(21) Appl. No.: 17/406,431

(22) Filed: Aug. 19, 2021

(51) Int. Cl. G06N 3/08; G06N 3/04; B60W 10/04; B60W 40/02

(52) U.S. Cl. CPC G06N 3/08; G06N 3/0454; B60W 10/04; B60W 40/02; B60W 2510/083; B60W 2710/083; B60W 2756/10; B60W 2400/00

(57) ABSTRACT

Data from a vehicle subsystem are input to a machine learning program trained to output a plurality of temporal pattern vectors. The temporal pattern vectors are input to an attention-based encoder trained to output a latent feature matrix. Each of the latent feature vectors is assigned to a respective one of a plurality of clusters. Based on the assigned clusters, an operation value is output to a controller of the vehicle subsystem.

### BACKGROUND

Vehicles can be equipped with computing devices, networks, sensors and controllers to acquire data regarding the vehicle's environment and to operate the vehicle based on the data. Operation of the vehicle can rely upon acquiring accurate and timely data regarding vehicle subsystem operation while the vehicle is being operated on a roadway.

### BRIEF DESCRIPTION OF THE DRAWINGS

FIG. 1 is a block diagram of an example system for operating a vehicle.

FIG. 2 is a block diagram of a model to output operation values for operating the vehicle.

FIG. 3 is a block diagram of an example neural network.

FIG. 4 is a block diagram of an example process to provide output operation values for operating the vehicle.

### DETAILED DESCRIPTION

A system includes a computer including a processor and a memory, the memory storing instructions executable by the processor to input data from a vehicle subsystem to a machine learning program trained to output a plurality of temporal pattern vectors that include data describing operation parameters of the vehicle subsystem, input the temporal pattern vectors to an attention-based encoder trained to output a latent feature matrix that includes a plurality of latent feature vectors that each include data describing a respective weight of each temporal pattern vector relative to each other temporal pattern vector, assign each of the latent feature vectors to a respective one of a plurality of clusters, and, based on the assigned clusters, output an operation value to a controller of the vehicle subsystem that is programmed to adjust operation of the vehicle subsystem to the output operation value.

The instructions can further include instructions to generate a map of predicted operation values based on the assigned clusters.

The instructions can further include instructions to input new operation data to update the map and to output predicted operation values from the map to the controller.

The instructions can further include instructions to determine a probability matrix of the latent feature matrix based on a cluster centroid matrix, the cluster centroid matrix including respective cluster centroids of each cluster, the probability matrix including data describing respective distributions of the latent feature vectors from the cluster centroids, and assign each of the latent feature vectors to a respective one of the plurality of clusters based on the probability matrix.

Each cluster can include data about an environment in which the operation data are collected.

The vehicle subsystem can be a powertrain, the operation data can be a measured torque, the output operation value can be a prescribed torque, and the controller can be further programmed to actuate the powertrain to output the prescribed torque.

The controller can be further programmed to collect torque data from the powertrain based on the prescribed torque, and the instructions can further include instructions to receive the collected torque data from the controller.

The instructions can further include instructions to collect the operation data from one or more electronic control units of the vehicle subsystem.

The instructions can further include instructions to assign each of the latent feature vectors to one of the plurality of clusters with a second machine learning program.

The instructions can further include instructions to input a plurality of sets of time-series operation data, each set of time-series operation data including operation data for a specified period of time, and to fuse the plurality of sets of time-series operation data into the latent feature matrix.

A first one of the plurality of sets of time-series operation data can include operation data for a first specified period of time and a second one of the plurality of sets of time-series operation data can include operation data for a second specified period of time, the first specified period of time being different than the second specified period of time.

The machine learning program can be a recurrent neural network.

The instructions can further include instructions to input operation data from respective vehicle subsystems of a plurality of vehicles to the machine learning program.

The instructions can further include instructions to generate a map of predicted operation values based on the assigned clusters and to transmit the map to a respective computer of each of the plurality of vehicles.

A method includes inputting data from a vehicle subsystem to a machine learning program trained to output a plurality of temporal pattern vectors that include data describing operation parameters of the vehicle subsystem, inputting the temporal pattern vectors to an attention-based encoder trained to output a latent feature matrix that includes a plurality of latent feature vectors that each include data describing a respective weight of each temporal pattern vector relative to each other temporal pattern vector, assigning each of the latent feature vectors to a respective one of a plurality of clusters, and based on the assigned clusters, outputting an operation value to a controller of the vehicle subsystem that is programmed to adjust operation of the vehicle subsystem to the output operation value.

The method can further include generating a map of predicted operation values based on the assigned clusters.

The method can further include inputting new operation data to update the map and outputting predicted operation values from the map to the controller.

The method can further include determining a probability matrix of the latent feature matrix based on a cluster centroid matrix, the cluster centroid matrix including respective cluster centroids of each cluster, the probability matrix including data describing respective distributions of the latent feature vectors from the cluster centroids, and assigning each of the latent feature vectors to a respective one of the plurality of clusters based on the probability matrix.

The controller can be further programmed to collect torque data from the powertrain based on the prescribed torque, and the method can further include receiving the collected torque data from the controller.

The method can further include collecting the operation data from one or more electronic control units of the vehicle subsystem.

The method can further include assigning each of the latent feature vectors to one of the plurality of clusters with a second machine learning program.

The method can further include inputting a plurality of sets of time-series operation data, each set of time-series operation data including operation data for a specified period of time, and fusing the plurality of sets of time-series operation data into the latent feature matrix.

The method can further include inputting operation data from respective vehicle subsystems of a plurality of vehicles to the machine learning program.

The method can further include generating a map of predicted operation values based on the assigned clusters and to transmit the map to a respective computer of each of the plurality of vehicles.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Vehicle subsystems can be calibrated according to specified driving scenarios, such as certification drive cycles. These driving scenarios allow manufacturers to generate control directives for the vehicle to control the subsystems. However, the driving scenarios may not capture specific driving styles or particular features of driving environments that differ from the specified driving scenarios. In particular, modeling nonlinear behavior of vehicle operation can be difficult for conventional physics-based control techniques that can rely on time-dependence of data collection.

A deep learning data-driven model can account for the time-dependent nature of data collection and nonlinear physical behavior of vehicle operation, providing outputs for controllers of vehicle subsystems that capture actual behavior of vehicles compared to conventional control techniques. Machine learning programs such as recurrent neural networks and attention-based encoders can identify temporal and spatial patterns in data from the vehicle, and clustering programs can identify outputs for vehicle subsystems to attain. These machine learning programs can process data collected at different periods of time and at different sampling rates to identify patterns independent of the temporal effects of data collection. Thus, control of vehicle subsystems is improved based on actual data collected during vehicle operation.

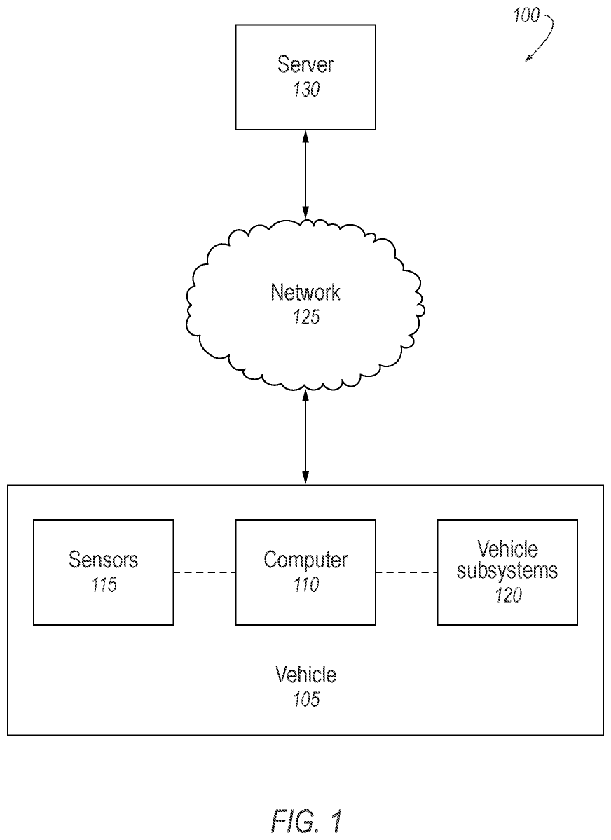

FIG. 1 is a block diagram of an example system 100 for operating a vehicle 105 including a computer 110. A vehicle 105 may be any suitable type of ground vehicle 105, e.g., a passenger or commercial automobile such as a sedan, a coupe, a truck, a sport utility, a crossover, a van, a minivan, a taxi, a bus, etc.

The computer 110 includes a processor and a memory. The memory includes one or more forms of computer-readable media, and stores instructions executable by the vehicle computer 110 for performing various operations, including as disclosed herein. For example, the computer 110 can be a generic computer 110 with a processor and memory as described above and/or may include an electronic control unit ECU or controller for a specific function or set of functions, and/or a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer 110.

The memory can be of any type, e.g., hard disk drives, solid state drives, servers 130, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

The computer 110 may include programming to operate one or more of vehicle 105 brakes, propulsion e.g., control of acceleration in the vehicle 105 by controlling one or more of an internal combustion engine, electric motor, hybrid engine, etc., steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 105 network such as a communications bus as described further below, more than one processor, e.g., included in components such as sensors 115, electronic control units (ECUs) or the like included in the vehicle 105 for monitoring and/or controlling various vehicle components, e.g., a powertrain controller, a brake controller, a steering controller, etc. The computer 110 is generally arranged for communications on a vehicle 105 communication network that can include a bus in the vehicle 105 such as a controller area network CAN or the like, and/or other wired and/or wireless mechanisms. Alternatively or additionally, in cases where the computer 110 actually comprises a plurality of devices, the vehicle 105 communication network may be used for communications between devices represented as the computer 110 in this disclosure. Further, as mentioned below, various controllers and/or sensors 115 may provide data to the computer 110 via the vehicle communication network.

Vehicles 105, such as autonomous or semi-autonomous vehicles 105, typically include a variety of sensors 115. A sensor is a device that can obtain one or more measurements of one or more physical phenomena. Some sensors 115 detect internal states of the vehicle 105, for example, wheel speed, wheel orientation, and engine and transmission variables. Some sensors 115 detect the position or orientation of the vehicle 105, for example, global positioning system GPS sensors 115; accelerometers such as piezo-electric or microelectromechanical systems MEMS; gyroscopes such as rate, ring laser, or fiber-optic gyroscopes; inertial measurements units IMU; and magnetometers. Some sensors 115 detect the external world, for example, radar sensors 115, scanning laser range finders, light detection and ranging LIDAR devices, and image processing sensors 115 such as cameras. A LIDAR device detects distances to objects by emitting laser pulses and measuring the time of flight for the pulse to travel to the object and back. Some sensors 115 are communications devices, for example, vehicle-to-infrastructure V2I or vehicle-to-vehicle V2V devices. Sensor operation can be affected by obstructions, e.g., dust, snow, insects, etc. Often, but not necessarily, a sensor includes a digital-to-analog converter to converted sensed analog data to a digital signal that can be provided to a digital computer 110, e.g., via a network. Sensors 115 can include a variety of devices, and can be disposed to sense and environment, provide data about a machine, etc., in a variety of ways. For example, a sensor could be mounted to a stationary infrastructure element on, over, or near a road. Moreover, various controllers in a vehicle 105 may operate as sensors 115 to provide data via the vehicle 105 network or bus, e.g., data relating to vehicle 105 speed, acceleration, location, subsystem 120 and/or component status, etc. Further, other sensors 115, in or on a vehicle 105, stationary infrastructure element, etc., infrastructure could include cameras, short range radar, long range radar, LIDAR, and/or ultrasonic transducers, weight sensors 115, accelerometers, motion detectors, etc., i.e., sensors 115 to provide a variety of data. To provide just a few non-limiting examples, sensor data could include data for determining a position of a component, a location of an object, a speed of an object, a type of an object, a slope of a roadway, a temperature, an presence or amount of moisture, a fuel level, a data rate, etc.

A vehicle subsystem 120 is a set of components or parts, including hardware components and typically also software and/or programming, to perform a function or set of operations in the vehicle 105. Vehicle subsystems 120 typically include, without limitation, a braking system, a propulsion system, and a steering system. The propulsion subsystem 120 converts energy to rotation of vehicle 105 wheels to propel the vehicle 105 forward and/or backward. The braking subsystem 120 can slow and/or stop vehicle 105 movement. The steering subsystem 120 can control a yaw, e.g., turning left and right, maintaining a straight path, of the vehicle 105 as it moves.

A computer 110 can be programmed to communicate with one or more remote sites such as a server 130, via a wide area network 125. The wide area network 125 can include one or more mechanisms by which a vehicle computer 110 may communicate with, for example, a remote server 130. Accordingly, the network can include one or more of various wired or wireless communication mechanisms, including any desired combination of wired e.g., cable and fiber and/or wireless e.g., cellular, wireless, satellite, microwave, and radio frequency communication mechanisms and any desired network topology or topologies when multiple communication mechanisms are utilized. Exemplary communication networks include wireless communication networks e.g., using Bluetooth, Bluetooth Low Energy BLE, IEEE 802.11, vehicle-to-vehicle V2V or vehicle 105 to everything V2X such as cellular V2X CV2X, Dedicated Short Range Communications DSRC, etc., local area networks LAN and/or wide area networks 125 WAN, including the Internet, providing data communication services.

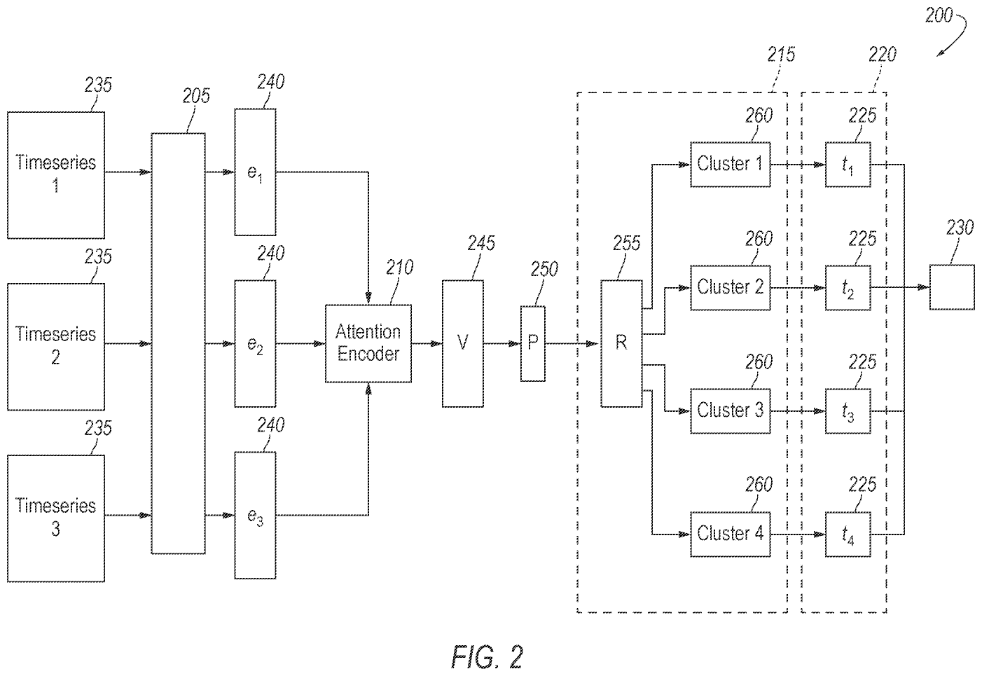

FIG. 2 is a block diagram of an example operating model 200 to operate a vehicle 105. The model 200 can be implemented as programming of a computer 110 of a vehicle 105 and/or an external server 130. The operating model 200 includes a temporal pattern vector generator 205, a latent feature matrix generator 210, a clustering program 215, and a target output identifier 220. Each of these portions of the operating model 200 modify input operation data from a vehicle 105 subsystem 120 to output a specified operation value 225 that a controller 230 of the subsystem 120 can use to operate the subsystem 120. For example, the model 200 can receive, as input, a throttle position, an exhaust camshaft angle, an intake camshaft angle, an engine speed, and/or a vehicle 105 speed to output one or more operation values 225 such as a target total fuel consumption and/or a total output torque. When the model 200 is implemented in the external server 130, the server 130 can receive inputs from the computer 110 of the vehicle 105 via a wide area network 125 and can transmit outputs to the computer 110 via the wide area network 125.

The computer 110 and/or server 130 can input time-series data 235 to the model 200. In this context, “time-series” data are operation data collected from one or more subsystems 120 that include timestamps at which the data were collected. That is, each data point in the operation has a corresponding timestamp. The time-series data 235 can be for example one or more of the example inputs to the model 200 described above, e.g., a throttle position, an exhaust camshaft angle, an intake camshaft angle, an engine speed, a vehicle 105 speed, etc. Collecting time-series data 235 allows the model 200 to consider temporal patterns of vehicle 105 subsystem 120 operation. The computer 110 can collect the operation data from one or more electronic control units of each vehicle 105 subsystem 120.

The computer 110 and/or server 130 can input the time-series data 235 to a temporal pattern vector generator 205 to generate a temporal pattern vector 240. A “temporal pattern vector” in this context is a vector that includes values representing behavioral patterns for the time period indicated by the time-series data 235, i.e., “temporal patterns.” That is, the temporal vector generator generates a temporal pattern vector 240 from the time-series data 235 that includes data describing operation parameters of one or more vehicle subsystems 120 over a specified period of time that the data was collected. Because different time-series data 235 may be collected at different sampling rates from one or more sensors 115, the temporal vector removes the specific temporal dependence on individual data points while detecting temporal changes to the vehicle behavior throughout the data collection period. The temporal pattern vector generator 205 can be a recurrent neural network (RNN) such as a long short-term memory (LSTM) model, e.g., TensorFlow, Keras, etc. The temporal pattern vector generator 205 can be trained in a conventional manner, e.g., with an annotated set of data from subsystems 120 of a test vehicle 105.

To compute the temporal pattern vectors 240, the RNN, implemented on the computer 110 and/or the server 130, transforms the input time series data 235 described above into a plurality of vectors eᵢ, where e is a variable for the temporal pattern vector 240 and i is an integer index. The machine learning program described above, such as the LSTM model, transforms each set of time series data 235 to a specific temporal pattern vector eᵢ that encodes temporal patterns within the time series data 235 while removing changes in sampling frequency at which each set of time series data 235 was collected. That is, given respective sets of time series data 235 with different sampling frequencies, e.g., a throttle position, an engine speed, and a camshaft angle, the temporal pattern vectors can preserve temporal patterns for the respective time series data 235 while allowing the respective sets of data 235 to be compared and/or used together as input even though their sampling frequencies were different. In the example of FIG. 2, three sets of time-series data 235 are input to the temporal pattern vector generator 205 to output three temporal pattern vectors 240, e₁, e₂, e₃.

The computer 110 and/or server 130 can input the temporal pattern vectors 240 to a latent feature matrix generator 210 that outputs a latent feature matrix 245. A “latent feature matrix” in this context is a matrix that includes a plurality of latent feature vectors defining weights for each temporal pattern vector 240, the weights indicating a relative amount that respective temporal pattern vectors 240 are assigned in overall operation of the vehicle 105. The latent feature matrix 245 encodes “spatial patterns” in the temporal pattern vectors, i.e., patterns between each temporal pattern vector and each other temporal pattern vector, where all of the temporal pattern vectors define the “space” within which the latent feature matrix encodes patterns. The latent feature matrix 245 fuses a plurality of sets of operation data, each set of operation data collected at a specified period of time that may differ from the period of time at which a different set of operation data may have been collected. The latent feature vectors include data describing a relative weight of each temporal pattern vector 240 relative to each other temporal pattern vector 240. The latent feature matrix generator 210 program is an attention-based encoder, as is known, that outputs a latent feature matrix 245 from input temporal pattern vectors 240. The latent feature matrix 245 is a matrix that includes numeric values that identify and characterize vehicle behavior independent of the times at which the data defining the temporal pattern vectors 240 were collected.

To generate the latent feature matrix 245, the latent feature matrix generator 210 transforms each temporal pattern vector eᵢ to a transformed vector kᵢ according to a transforming variable matrix Aᵢ:

kᵢ=Aᵢ·eᵢ (1)

The transforming variable matrix Aᵢ is a variable matrix of the attention-based encoder that is initialized to a predetermined set of values determined during training of the attention-based encoder. As described above for the temporal pattern vector generator 205, the latent feature matrix generator is trained with an annotated set of data from subsystems 120 of a test vehicle 105 to generate the initialized weight variables.

The latent feature matrix generator 210 can then determine a query vector qᵢ for the temporal pattern vector eᵢ based on a query weight matrix Bᵢ initialized to a predetermined set of weights determined during training of the attention-based encoder:

qᵢ=Bᵢ·eᵢ (2)

A value vector lᵢ is then determined for the temporal pattern vector eᵢ based on a value variable matrix Cᵢ initialized to a predetermined set of weights determined during training of the attention-based encoder. The weights of the value variable matrix Cᵢ serve as a statistical measure to determine dependencies of temporal pattern vectors eᵢ to each other.

lᵢ=Cᵢ·eᵢ (3)

Upon determining the vectors kᵢ, qᵢ, lᵢ, the attention-based encoder can determine an attention score vector αᵢ that determines a respective weight to apply to each temporal pattern vector eᵢ and a timeseries correlated vector hᵢ that is a weighted sum of the value vectors lᵢ, from which a latent feature vector v can be calculated:

αᵢ=softmax(qᵢ·kᵢ) (4)

$${h}_{i} = {\sum }_{j}^{m} {α}_{i j} {l}_{j} \qquad ( 5 )$$

v=mean(hᵢ∀i) (6)

where m is a total number of sets of timeseries data 235, softmax( ) is a conventional softmax function, and v is the elementwise mean of the timeseries correlated vectors hᵢ. The attention-based encoder outputs a latent feature matrix 245, represented with the variable V, as the concatenation of the set of latent feature vectors v.

The computer 110 and/or server 130 can transform the latent feature matrix 245 with a cluster centroid matrix to a cluster distribution matrix 250 and reconstruct an approximation matrix 255, represented by the variable R, from the cluster distribution matrix 250. The “approximation matrix” is a matrix that approximates values of the latent feature matrix 245 that can be input to a clustering program 215. That is, the data of the latent feature matrix 245 output from the attention-based encoder may not be in a format compatible with the clustering program 215, and the approximation matrix 255 transforms the data into a format compatible with the clustering program 215 while preserving relationships between the feature vectors encoded in the latent feature matrix 245. The computer 110 and/or server 130 can identify one or more clusters 260 in the reconstructed approximation matrix 255 with a clustering program 215, described below. The cluster centroid matrix is a matrix of respective centroids of a plurality of data clusters 260, the data clusters 260 including operation data with high similarities in latent feature vectors. The cluster distribution matrix 250 is a matrix that encodes distributions of the latent feature vectors from the cluster centroids in the cluster centroid matrix.

To determine the reconstructed approximation matrix 255, represented by the variable R, the computer 110 and/or server 130 determines a cluster distribution matrix 250, represented with the variable P, based on the latent feature matrix 245, represented with the variable V, and the cluster centroid matrix, represented with the variable W:

P=softmax(W·V+b) (7)

R=τ^{T}·P (8)

where b is an offset value determined during the construction of the cluster centroid matrix W and training of the clustering program 215, r is a data probability distribution matrix over the clusters 260 determined during training of the clustering program 215, which encodes a respective probability that each latent feature vector of the latent feature matrix 245 would be assigned to each of the clusters 260 of the cluster centroid matrix.
T is the matrix transpose operator as conventionally understood.

The computer 110 and/or server 130 transforms the latent feature matrix 245 so that the clustering program 215 can assign each of the latent feature vectors v to a respective one of the plurality of clusters 260 from which the cluster centroid matrix is determined. That is, to cluster the data, a matrix factorization approach can be applied to decompose the latent feature matrix 245 into the data probability distribution matrix r and the cluster probability matrix 250, and the product of these two matrices generates the approximation matrix 255 that approximates the latent feature matrix 245. An approximation error can be minimized through iterations during training, and the cluster centroid matrix W and the data probability distribution matrix r are determined when the approximation error is minimized. The clustering program 215 then outputs an assigned cluster 260 for each of the latent feature vectors encoded in the approximation matrix 255. The example of FIG. 2 shows four clusters 260 to which the latent feature vectors v may be assigned.

The computer 110 and/or server 130 can input the assigned clusters 260 to a target output identifier 220 that outputs operation values 225 based on respective assigned clusters 260. The target output identifier 220 can be a regression model that outputs a predicted operation value 225 for the subsystem 120. The regression model can be, e.g., a linear regression model that determines a linear relationship between the data in the assigned cluster 260 and the latent feature vector encoded in the clustered data matrix to output the operation value 225. The computer 110 can output the operation values 225 to the controller 230, and the controller 230 can adjust operation of one or more subsystems 120 to the output operation values 225. For example, when the subsystem 120 is a powertrain, the output operation values 225 can be a prescribed fuel consumption and a prescribed torque output, and the controller 230 can adjust operation of the powertrain (such as adjusting a camshaft angle and/or a throttle position) to output the prescribed torque at the prescribed fuel consumption output operation value 225. The example of FIG. 2 shows four regression model outputs t₁, t₂, t₃, t₄, one from each of the clusters 260, each regression output t₁ being data describing a target fuel consumption and a target torque output.

The computer 110 and/or server 130 can generate a map of predicted operation values 225 based on the assigned clusters 260. A “map” in this context is a data file (such as a lookup table or the like) that stores inputs to the model 200 and outputs from the model 200, “mapping” the inputs to the outputs. That is, with the map, the computer 110 and/or the server 130 can, based on new operation data, predict the output from the model 200 without processing the operation data through each step of the model 200. Thus, by generating the map, the computer 110 and/or the server 130 can prescribe outputs for the controller 230 with fewer computations from the machine learning programs described above that would not be calculated. The computer 110 and/or server 130 can update the map with new operation data and output the predicted operation values 225 from the map to the controller 230. The computer 110 and/or the server 130 can generate outputs and update the map based on the outputs. For example, when the subsystem 120 is a powertrain, the controller 230 can be further programmed to collect torque data from the powertrain based on the target torque output and to receive the collected torque data from the controller 230. The controller 230 can send the collected torque data to the computer 110 and/or the server 130, and the computer 110 and/or the server 130 can input the collected torque data to the model 200 to update the map.

The server 130 can generate and update the map with operation data from a plurality of vehicles 105 input to the model 200 to provide output operation values 225. That is, rather than generating the map with data from a single vehicle 105, the server 130 can collect operation data from a plurality of vehicles 105 with a plurality of respective subsystems 120 and generate output operation values 225 based on the clusters 260 output from the clustering program 215. The server 130 can generate the map based on the assigned clusters 260 and can transmit the map a respective computer 110 of each of the plurality of vehicles 105 from which the data were collected. Generating the map with data from the plurality of vehicles 105 can improve the output from the map to account for different operation of the vehicles 105 that may not be captured when using data from only one vehicle 105.

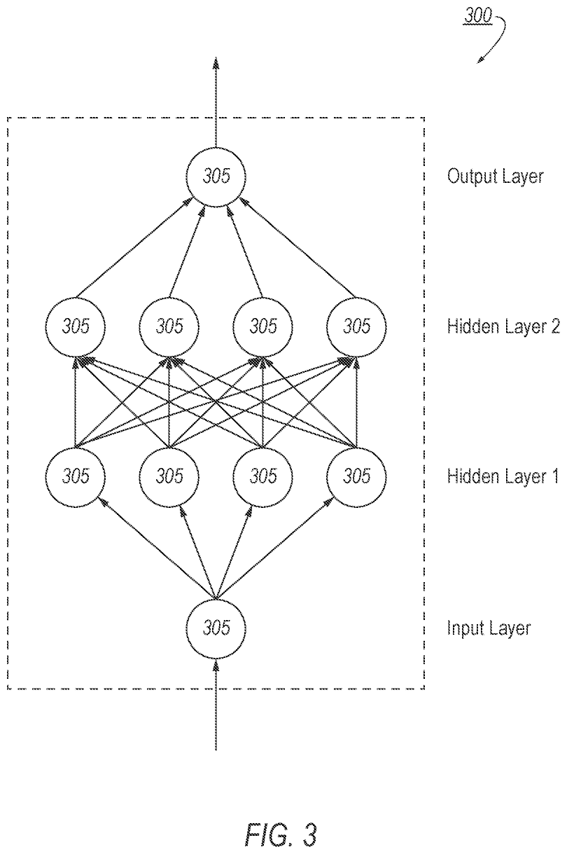

FIG. 3 illustrates an example deep neural network (DNN) 300, such as the temporal pattern vector generator 205 described above and shown in FIG. 2. A DNN 300 can be a software program that can be loaded in memory and executed by a processor included in a computer 110 and/or server 130, for example. In an example implementation, the DNN 300 can include, but is not limited to, a convolutional neural network CNN, R-CNN Region-based CNN, Fast R-CNN, and Faster R-CNN. The DNN 300 includes multiple nodes or neurons 305. The neurons 305 are arranged so that the DNN 300 includes an input layer, one or more hidden layers, and an output layer. Each layer of the DNN 300 can include a plurality of neurons 305. While three hidden layers are illustrated, it is understood that the DNN 300 can include additional or fewer hidden layers. The input and output layers may also include more than one node. As one example, the DNN 300 can be trained with ground truth data, i.e., data about a real-world condition or state. For example, the DNN 300 can be trained with ground truth data and/or updated with additional data. Weights can be initialized by using a Gaussian distribution, for example, and a bias for each node can be set to zero. Training the DNN 300 can include updating weights and biases via suitable techniques such as back-propagation with optimizations. Ground truth data means data deemed to represent a real-world environment, e.g., conditions and/or objects in the environment. Thus, ground truth data can include sensor data indicating operation of a vehicle subsystem 120, e.g., operation data from a component, along with a label or labels describing the environment, e.g., a label describing the subsystem 120 from which the data were collected and a type of data collected from the subsystem. Ground truth data can further include or be specified by metadata such as a location or locations at which the ground truth data was obtained, a time of obtaining the ground truth data, etc.

The nodes are sometimes referred to as artificial neurons 305, because they are designed to emulate biological, e.g., human, neurons 305. A set of inputs represented by the arrows to each neuron 305 are each multiplied by respective weights. The weighted inputs can then be summed in an input function to provide, possibly adjusted by a bias, a net input. The net input can then be provided to an activation function, which in turn provides a connected neuron 305 an output. The activation function can be a variety of suitable functions, typically selected based on empirical analysis. As illustrated by the arrows in the figure, neuron 305 outputs can then be provided for inclusion in a set of inputs to one or more neurons 305 in a next layer.

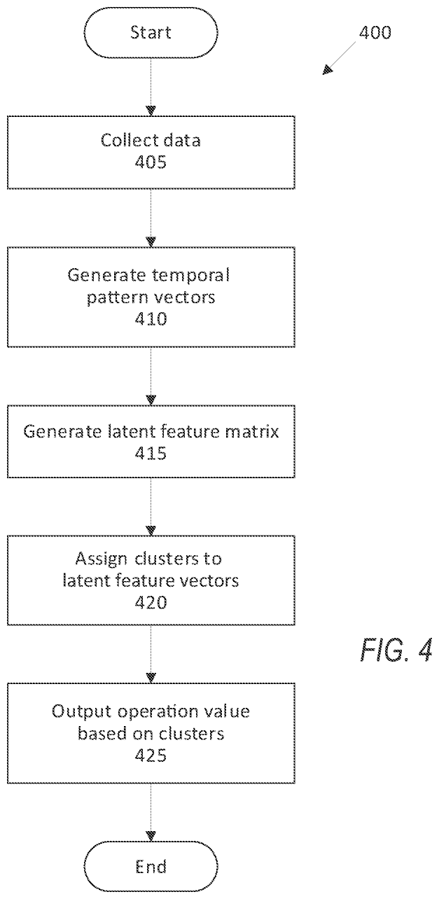

FIG. 4 is a block diagram of an example process 400 for operating a vehicle 105. The process 400 begins in a block 405, in which a computer 110 of the vehicle 105 collects operation data from one or more vehicle 105 subsystems 120. The computer 110 can collect the operation data from respective electronic control units of the one or more vehicle 105 subsystems 120. For example, the computer 110 can collect time-series data 235, i.e., data that include specific timestamps indicating a time at which the data were collected.

Next, in a block 410, the computer 110 inputs the operation data to a temporal pattern vector generator 205 to generate a plurality of temporal pattern vectors 240. As described above, the temporal pattern vectors 240 represent behavioral patterns of the operation data based on the times at which the data were collected. The temporal pattern vector generator 205 can be a machine learning program, e.g., a recurrent neural network.

Next, in a block 415, the computer 110 inputs the temporal pattern vectors 240 to a latent feature matrix generator 210 to generate a latent feature matrix 245. As described above, the latent feature matrix 245 includes a plurality of latent feature vectors that capture spatial patterns in the operation data independent of the temporal patterns captured by the temporal pattern vectors 240. The latent feature matrix generator 210 is an attention-based machine learning program.

Next, in a block 420, the computer 110 assigns each latent feature vector of the latent feature matrix 245 to one of a plurality of clusters 260. As described above, the computer 110 can generate a reconstructed approximation matrix 255 based on the decomposition of the latent feature matrix 245 into a data probability distribution matrix r and a cluster probability matrix 250. The probability distribution matrix r encodes a probability that each latent feature vector would be assigned to each of the plurality of clusters 260, centroids of which are included in a cluster centroid matrix used to generate the cluster distribution matrix 250. Then, the computer 110 inputs the reconstructed approximation matrix 255 to a clustering program 215 to assign each of the latent feature vectors to one of the clusters 260.

Next, in a block 425, the computer 110 outputs a prescribed operation value 225 based on the assigned clusters 260. The computer 110 can input the assigned clusters 260 to a target output identifier 220 that predicts output operation values 225 for the subsystems 120 of the vehicle 105. For example, the target output identifier 220 can be a regression model. A controller 230 of one or more of the subsystems 120 can adjust operation of the subsystems 120 to attain the output prescribed operation values 225. For example, the controller 230 can adjust a camshaft angle of a camshaft and/or a throttle position of a throttle of a powertrain to attain a target fuel consumption and/or a target torque output. Following the block 425, the process 400 ends.

Computer-executable instructions may be compiled or interpreted from computer 110 programs created using a variety of programming languages and/or technologies, including, without limitation, and either alone or in combination, Java, C, C, Visual Basic, Java Script, Perl, HTML, etc. In general, a processor e.g., a microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a networked device is generally a collection of data stored on a computer-readable medium, such as a storage medium, a random access memory, etc. A computer-readable medium includes any medium that participates in providing data e.g., instructions, which may be read by a computer 110. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer 110. Common forms of computer-readable media include, for example, RAM, a PROM, an EPROM, a FLASH-EEPROM, any other memory chip or cartridge, or any other medium from which a computer 110 can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising a computer including a processor and a memory, the memory storing instructions executable by the processor to:
input data from a vehicle subsystem to a machine learning program trained to output a plurality of temporal pattern vectors that include data describing operation parameters of the vehicle subsystem;
input the temporal pattern vectors to an attention-based encoder trained to output a latent feature matrix that includes a plurality of latent feature vectors that each include data describing a respective weight of each temporal pattern vector relative to each other temporal pattern vector;
assign each of the latent feature vectors to a respective one of a plurality of clusters; and
based on the assigned clusters, output an operation value to a controller of the vehicle subsystem that is programmed to adjust operation of the vehicle subsystem to the output operation value.

2. The system of claim 1, wherein the instructions further include instructions to generate a map of predicted operation values based on the assigned clusters.

3. The system of claim 2, wherein the instructions further include instructions to input new operation data to update the map and to output predicted operation values from the map to the controller.

4. The system of claim 1, wherein the instructions further include instructions to:
determine a probability matrix of the latent feature matrix based on a cluster centroid matrix, the cluster centroid matrix including respective cluster centroids of each cluster, the probability matrix including data describing respective distributions of the latent feature vectors from the cluster centroids; and
assign each of the latent feature vectors to a respective one of the plurality of clusters based on the probability matrix.

5. The system of claim 4, wherein each cluster includes data about an environment in which the operation data are collected.

6. The system of claim 1, wherein the vehicle subsystem is a powertrain, the operation data is a measured torque, the output operation value is a prescribed torque, and the controller is further programmed to actuate the powertrain to output the prescribed torque.

7. The system of claim 6, wherein the controller is further programmed to collect torque data from the powertrain based on the prescribed torque, and the instructions further include instructions to receive the collected torque data from the controller.

8. The system of claim 1, wherein the instructions further include instructions to collect the operation data from one or more electronic control units of the vehicle subsystem.

9. The system of claim 1, wherein the instructions further include instructions to assign each of the latent feature vectors to one of the plurality of clusters with a second machine learning program.

10. The system of claim 1, wherein the instructions further include instructions to input a plurality of sets of time-series operation data, each set of time-series operation data including operation data for a specified period of time, and to fuse the plurality of sets of time-series operation data into the latent feature matrix.

11. The system of claim 10, wherein a first one of the plurality of sets of time-series operation data includes operation data for a first specified period of time and a second one of the plurality of sets of time-series operation data includes operation data for a second specified period of time, the first specified period of time being different than the second specified period of time.

12. The system of claim 1, wherein the machine learning program is a recurrent neural network.

13. The system of claim 1, wherein the instructions further include instructions to input operation data from respective vehicle subsystems of a plurality of vehicles to the machine learning program.

14. The system of claim 13, wherein the instructions further include instructions to generate a map of predicted operation values based on the assigned clusters and to transmit the map to a respective computer of each of the plurality of vehicles.

15. A method, comprising:
inputting data from a vehicle subsystem to a machine learning program trained to output a plurality of temporal pattern vectors that include data describing operation parameters of the vehicle subsystem;
inputting the temporal pattern vectors to an attention-based encoder trained to output a latent feature matrix that includes a plurality of latent feature vectors that each include data describing a respective weight of each temporal pattern vector relative to each other temporal pattern vector;
assigning each of the latent feature vectors to a respective one of a plurality of clusters; and
based on the assigned clusters, outputting an operation value to a controller of the vehicle subsystem that is programmed to adjust operation of the vehicle subsystem to the output operation value.

16. The method of claim 15, further comprising generating a map of predicted operation values based on the assigned clusters.

17. The method of claim 15, wherein the vehicle subsystem is a powertrain, the operation data is a measured torque, the output operation value is a prescribed torque, and the controller is further programmed to actuate the powertrain to output the prescribed torque.

18. The method of claim 15, further comprising assigning each of the latent feature vectors to one of the plurality of clusters with a second machine learning program.

19. The method of claim 15, further comprising inputting a plurality of sets of time-series operation data, each set of time-series operation data including operation data for a specified period of time and fusing the plurality of sets of time-series operation data into the latent feature matrix.

20. The method of claim 15, further comprising inputting operation data from respective vehicle subsystems of a plurality of vehicles to the machine learning program.
